(19) United States
(12) Patent Application Publication
(10) Pub. No.: US 2025/0329927 A1
(43) Pub. Date: Oct. 23, 2025

(54) ANTENNA SYSTEMS

(71) Applicant: Parsec Technologies, Inc., Plano, TX (US)

(72) Inventors: Michael A. Neenan, Plano, TX (US); Richard Loy Smith, Dallas, TX (US); Rauhon Ahmed Shalk, Wylie, TX (US); George Alexander Bednekoff, Plano, TX (US)

(21) Appl. No.: 18/831,453

(22) Filed: Jan. 24, 2025

Related U.S. Application Data
(60) Provisional application No. 63/624,688, filed on Jan. 24, 2024.

(51) Int. Cl. H01Q 5/30; H01Q 1/42; H01Q 1/48; H01Q 9/06; H01Q 9/16

(52) U.S. Cl. CPC H01Q 5/30; H01Q 1/42; H01Q 1/48; H01Q 9/065; H01Q 9/16

(57) ABSTRACT

An antenna assembly may include a radome. The antenna assembly may include a printed circuit board (PCB) configured to be housed by the radome, wherein the PCB comprises a first side and a second side; a counter pose element formed on the first side of the PCB, wherein the counter pose element comprises one or more conductive elements, wherein lengths of the one or more conductive elements correspond to a band of operation for the antenna assembly. The antenna assembly may include a driven element formed on the second side of the PCB and comprising a slit that allows for current crowding of the driven element. The antenna assembly may include a feed element coupled to the PCB, wherein the feed element is configured to energize the driven element.

### INCORPORATION BY REFERENCE TO ANY PRIORITY APPLICATIONS

The present application claims priority benefit to U.S. Provisional Applications No. 63/624,688 filed Jan. 24, 2024, entitled “ANTENNA SYSTEMS,” No. 63/640,549 filed Apr. 30, 2024, entitled “ANTENNA SYSTEMS,” and No. 63/647,463 filed May 14, 2024, entitled “ANTENNA SYSTEMS,” which are each hereby incorporated by reference herein in their entireties. Any and all applications for which a foreign or domestic priority claim is identified in the Application Data Sheet as filed with the present application are hereby incorporated by reference under 37 CFR 1.57 and made a part of this specification.

### BACKGROUND

### Field

The present disclosure relates to the field of wireless broadband communication, and more particularly to antenna systems and antennas that cover multiple frequency bands used in the telecommunication wireless spectrum.

### Description of the Related Art

Over the last few decades, 3GPP as a collaborative organization has developed protocols for mobile telecommunications. The latest operational standard is known as 5G. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennas that are configured to electromagnetically resonate at frequencies within the dedicated bandwidth. As more wireless devices are used on a frequency bandwidth, a communication bottleneck occurs as wireless devices compete for frequency channels within a dedicated bandwidth. 3GPP frequency bands range from 450 MHz to 8 GHz and beyond, however, antennas configured to resonate within this spectrum only resonate below 8 GHz for mobile 3GPP telecommunication standards. To capture a greater portion of the 3GPP or other telecommunication spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems. This may result in a system with poor functionality and/or coverage.

### SUMMARY

One aspect of the disclosure provides an antenna assembly. The antenna assembly comprises a radome. The antenna assembly further includes at least two printed circuit boards (PCBs) configured to be housed by the radome, where each of the least two PCBs includes a first side and a second side. Each of the least two PCBs comprises a counter pose element formed on the first side, where the counter pose element includes one or more conductive elements, where lengths of the one or more conductive elements correspond to a band of operation for the antenna assembly. Each of the least two PCBs further comprises a driven element formed on the second side and including a slit that allows for current crowding of the driven element. The antenna assembly further includes a feed element coupled to each of the least two PCBs, where the feed element is configured to energize the driven element for each of the least two PCBs. The antenna assembly further includes a grounding portion coupled to each of the at least two PCBs.

The antenna assembly of the preceding paragraph can include any sub-combination of the following features: where the grounding portion includes a rigid material positioned along a straight line and configured to couple to a portion of the one or more conductive elements for each of the least two PCBs; where the slit for each of the least two PCBs is configured to adjust an electrical length of the driven element; where the electrical length of the driven element corresponds to a transmission frequency range, where the electrical length of the driven element is shorter than a physical length of the driven element at higher frequencies and the electrical length of the driven element is longer than the physical length of the driven element at lower frequencies; where the driven element includes a feedline that linearly tapers in width from a first point to a second point; where the feedline is configured to transform a feed impedance of a transmission line from a characteristic impedance to an impedance of the driven element; where the one or more conductive elements of the counter pose element include a plurality of radiating arms; where the plurality of radiating arms are each connected by a single feature; where at least two of the plurality of radiating arms are of a different length; where the plurality of radiating arms correspond to a frequency range, wherein a shortest radiating arm corresponds to a higher end of the frequency range and a longest radiating arm corresponds to a lower end of the frequency range; where the driven element includes a conductive layer, where the slit is included in the conductive layer; where the antenna assembly further comprises a pivotable arm coupled to the feed element and configured to pivot along an axis of rotation and provide the antenna assembly a plurality of orientations; where the radome includes two parts releasably joined together; where the antenna assembly is configured to produce omni-directional radiation pattern; where the antenna assembly is configured to produce directional radiation pattern; where the radome is configured to compress a gasket when assembled to be configured for outdoor use; where the feed element includes an outer conductor, an insulator, and an inner conductor; where the outer conductor is coupled to the first side for each of the at least two PCBs; where the inner conductor is coupled to the second side for each of the at least two PCBs; where the insulator is configured to electrically isolate the inner conductor from the outer conductor.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions in so far as they do not depart from the spirit and scope of the present application.

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

### BRIEF DESCRIPTION OF THE DRAWINGS

FIG. 1 illustrates a perspective view of an antenna assembly that includes a multi-element multi-band antenna enveloped by a non-conductive cover, a RF connection attachment that can articulate over a range and can form a right angle, according to some embodiments.

FIGS. 2A and 2B illustrate side and top perspective views, respectively. These views show the overall shape of the antenna assembly.

FIG. 3 illustrates a view of the antenna assembly with the non-conductive cover removed. This view demonstrates the mounting of the antenna assembly with respect to the non-conductive cover and adjustable connector.

FIGS. 4A and 4B illustrate perspective views with the non-conductive cover removed. These views demonstrate two sides of the antenna assembly including the counter-pose of the dipole with frequency dependent arms and the driven arm of the dipole with a slit in the conductive layer.

FIGS. 5A and 5B illustrate a perspective view with the non-conductive cover removed and illustrating the adjustable connector in a perspective and an exploded view.

FIGS. 6A and 6B illustrate an exemplary feed configuration of the antenna assembly.

FIGS. 7A and 7B illustrate an antenna assembly in accordance with another example implementation of the disclosure herein.

FIG. 8A illustrates a perspective view of an antenna assembly according to another example implementation of a disclosed embodiment.

FIG. 8B illustrates a rear view of the antenna assembly of FIG. 8A.

FIG. 8C illustrates a front view of the antenna assembly of FIG. 8A.

FIG. 8D illustrates a front view of the antenna assembly of FIG. 8A.

FIG. 8E illustrates a first side view of the antenna assembly of FIG. 8A.

FIG. 8F illustrates a second side view of the antenna assembly of FIG. 8A.

FIG. 8G illustrates a bottom view of the antenna assembly of FIG. 8A.

FIG. 8H illustrates a top view of the antenna assembly of FIG. 8A.

FIGS. 8I, 8J, 8K illustrate views of the antenna assembly and radome configured and adapted for use according to an example implementation of the disclosed embodiment of FIG. 8A.

FIGS. 8L, 8M, 8N illustrate views of one or more antennas in antenna orientations and configurations according to example implementations of disclosed embodiments.

FIGS. 8O, 8P, 8Q, 8R illustrate perspective views of one or more antennas according to example implementations of disclosed embodiments.

FIG. 9 illustrates an antenna system, the antenna system including an example implementation having a case to carry the antenna assemblies according to example implementations of disclosed embodiments.

While the implementations and method of the present application is susceptible to various modifications and alternative forms, specific implementations thereof have been shown by way of example in the drawings and are herein described in detail. It should be understood, however, that the description herein of specific implementations is not intended to limit the application to the particular implementation disclosed, but on the contrary, the intention is to cover all modifications, equivalents, and alternatives falling within the spirit and scope of the process of the present application as defined by the appended claims.

### DETAILED DESCRIPTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The system and method in accordance with the present disclosure overcomes one or more of the above-discussed problems commonly associated with traditional antenna systems. In particular, the system of the present disclosure is an antenna system having a radome, a coaxial connector and cable, a non-conductive laminate, groundplane and multi-arm counter-pose dipole arms on one side of the laminate, and tapered microstrip feed line with driven dipole arm with a slit on the opposing side of the laminate. The multiple arms for the counter pose of the dipole along with the slit in the driven arm of the dipole and the tapered microstrip line allow for the radiating element to have a frequency range of 600 MHz to 8 GHz, which provides a wider range of frequencies than antenna systems currently known in the art, with improved cost effectiveness and simplicity of manufacture. The driven arm has the slit which assists with the multi-band performance of the antenna. The counter pose is comprised of many different length arms to provide the multi-band performance. Most dipoles or monopoles resonant when the length of the arm is an odd multiple of a quarter wavelength. Having arms of different lengths allows for the resonances to stack next to one another across the frequency spectrum. In essence, the resonances are closely spaced enough to work in conjunction with the driven element to provide an antenna with a wide impedance and frequency bandwidth. This bandwidth allows for the antenna to be compact, making it ideal for compact 3GPP or other telecommunication transmitters. These and other unique features of the system are discussed below and illustrated in the accompanying drawings.

The system and method will be understood, both as to its structure and operation, from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary embodiment, however, alternate embodiments having scaled and proportional dimensions of the presented exemplary embodiment are also considered. Additional features and functions are illustrated and discussed below.

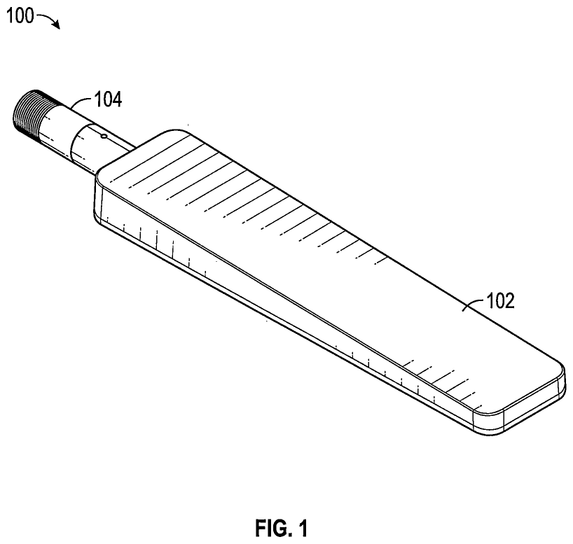

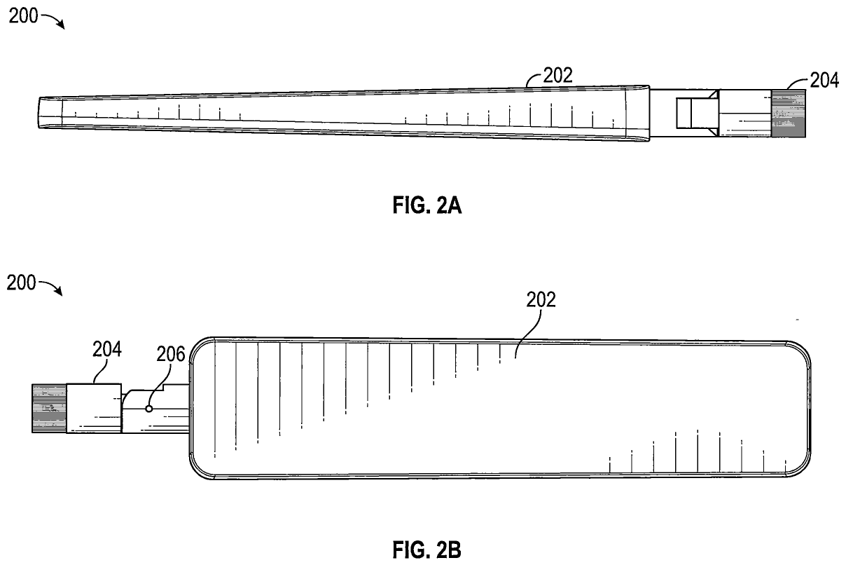

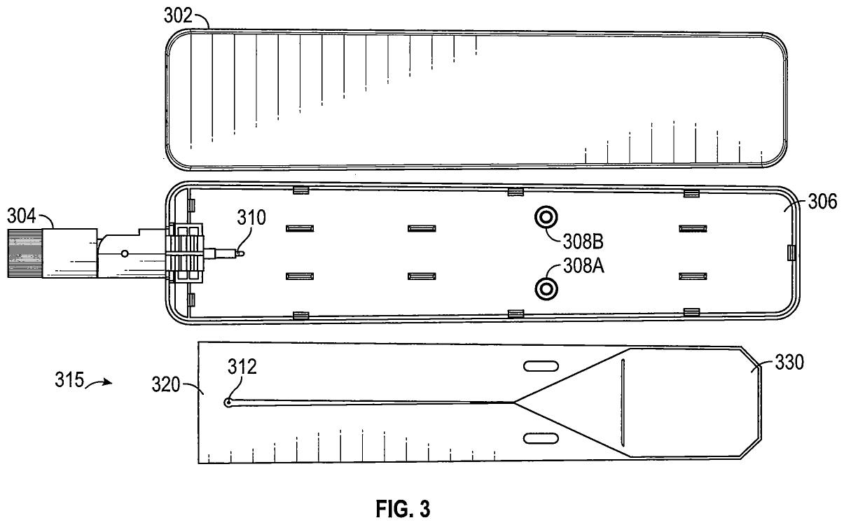

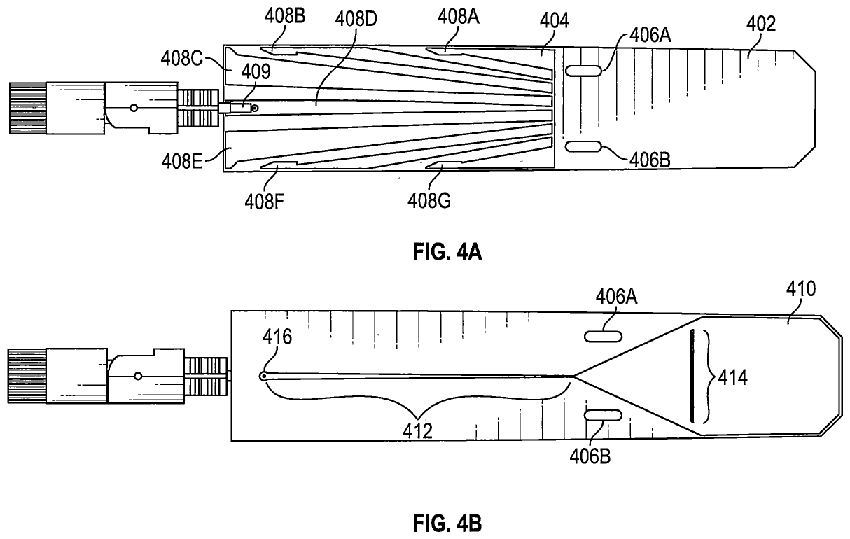

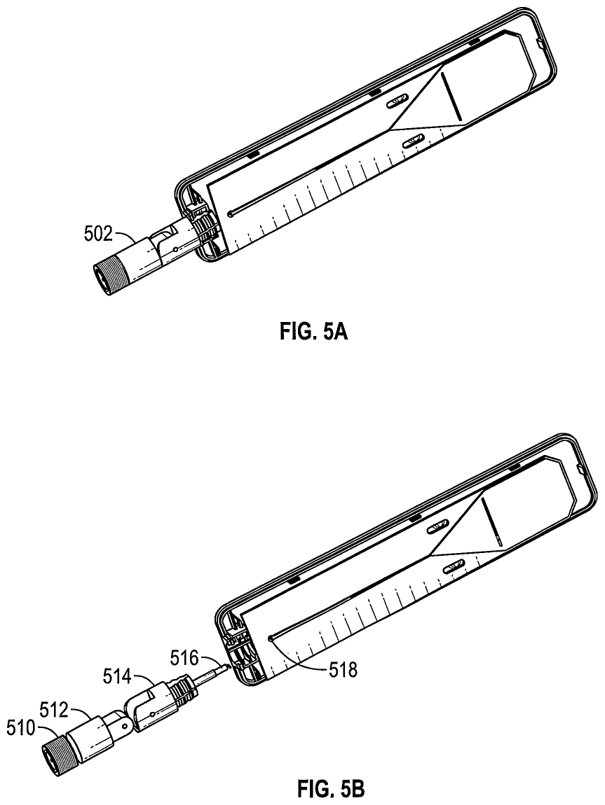

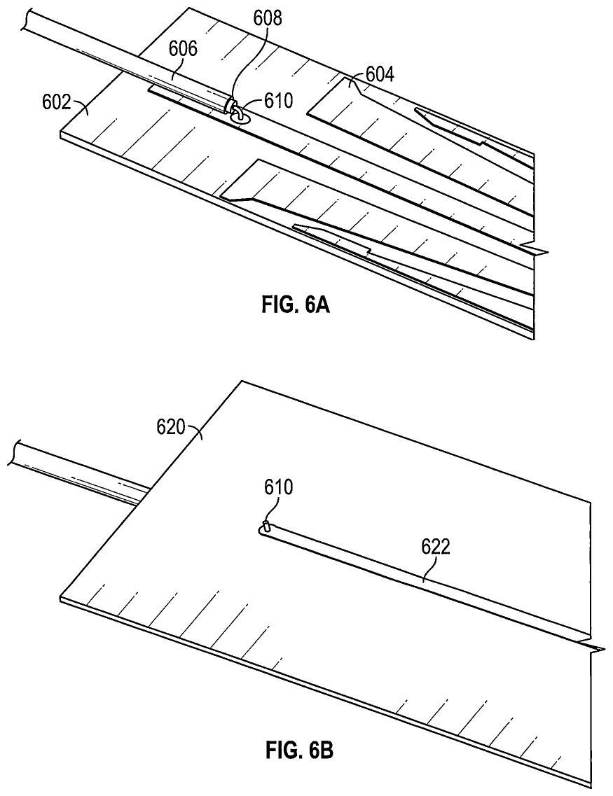

Referring now to the drawings wherein like reference characters identify corresponding or similar elements in form and function throughout the several views. FIG. 1 illustrates a perspective view on an antenna assembly 100, in accordance with some implementations. The antenna assembly 100 may include a radome 102 and a connector 104. FIGS. 2A and 2B illustrate perspective views of antenna assembly 200, in accordance with some implementations. The antenna assembly 200 may include a radome 202, a connector 204, and a pivotable point 206. FIG. 3 illustrates a perspective view of inner components of the antenna assembly (e.g., antenna assembly 100 in FIG. 1). FIG. 3 illustrates a radome component 302, a connector 304, an internal radome component 306, mechanical fasteners 308A,B, a coaxial feed 310, a feedpoint 312, an omni-directional antenna 315, a non-conductive surface 320, and a conductive surface 330. FIGS. 4A-4B illustrate perspective views of the inner components of the antenna assembly (e.g., antenna assembly 100 in FIG. 1). FIGS. 4A-4B illustrate a first non-conductive surface 402, a first conductive surface 404, mechanical fastening points 406A,B, conductive arms 408A-G, a coaxial feed 409, a second conductive surface 410, a feedline 412, a slit 414, and a feed point 416. FIGS. 5A-5B illustrate a connector assembly. The connector assembly may include formed connector 502, a base connector component 510, a base pivot connector component 512, a pivotable connector component 514, a coaxial feed 516, and a feed point 518. In some examples, the base pivot connector component 512 and/or the pivotable connector component 514 may pivot along an axis of rotation. FIGS. 6A-6B illustrate exemplary feed configuration of the antenna assembly. The exemplary feed configuration may include a first non-conductive surface 602, a first conductive surface 604, an outer conductor 606, an insulator 608, an inner conductor 610, a second non-conductive surface 620, and a second conductive surface 622.

As shown in FIG. 4A, the antenna assembly can include one or more omni-directional antennas to produce an omni-directional radiation pattern. In some instances, the antenna assembly may operate as directional to produce a directional radiation pattern. For example, the antenna assembly may include a reflector to provide directionality of a transmitted signal. In some instances, the one or more omni-directional antennas can each include multiple thin arms of different lengths (e.g., conductive arms 408A-G), also referred to as counter pose arms. This arrangement can allow for the active portion of the counter pose arms to mainly use the longest arms at the lower end of the frequency band. Additionally, as the frequency of operation moves up in value, the most active arm can be the center (middle length) of the three arms. When operating at the higher end of the frequency band, the smallest of the three arms can be most active. In some cases, as a frequency selection adjusts across the frequency band, the dominant active portion may also adjust. For example, the longest arm of the counterpose portion is a dominant active portion for the lowest frequency of operation. In some cases, the shorter arms may contribute in a significant fashion as their length approaches a quarter wavelength in size. As the frequency changes, the arms that are an odd multiple of a quarter wavelength of the frequency in size may contribute as the dominant active portion as well.

In some cases, the counter pose elements and the driven elements are etched features on a printed circuit board (PCB). The PCB may include a non-conductive surface and a conductive surface. In some cases, the conductive surface may be made from a thin sheet of conducting material. For example, the conductive material may be copper or sheet metal. In some cases, the non-conductive portion of the PCB material may be a piece of plastic or non-conductive foam. In some examples, the PCB may have any geometric shape, including at least a length and width. For example, the PCB may be rectangular (or substantially rectangular), having a length greater than a width. In some cases, the PCB may have the same (or substantially same) width along the length. In some examples, the PCB may have a width that varies along the length. For example, the width of the PCB may have a widest measure at or near a middle position along the length.

Using a PCB, the counter pose elements and the driven elements may include conductive features. In some examples, the conductive features may be copper or sheet metal. The conductive features may have a thickness of copper foil on the non-conducting substrate material (e.g., the PCB). In some cases, the driven element may be three inches long, however, the driven element may be longer or shorter based on the application. In some cases, the counter pose elements can be four inches in length of the longest arm and an inch in length of the shortest arm depending on the desired performance, however, the counter pose elements may be longer or shorter based on the application. In some instances, the different length arms are tied together by a single feature that connects to a groundplane of the microstrip transmission line impedance transformer.

In some implementations, the outer conductor of the small coaxial cable can be soldered to the groundplane (e.g., the center most copper portion in FIG. 6A) of the microstrip transmission line. In this manner, the outer conductor may be grounded to mitigate radiation from the coaxial cable. With reference to FIG. 4B below, the center conductor of the small coaxial cable can be soldered to feed line of the microstrip transmission line. The feedline is tapered so as to transform the feed impedance of the microstrip transmission line from the characteristic impedance of the coax to an impedance that more closely matches the impedance of the radiating structure.

As shown in FIG. 4B, the multi-band dipole antenna can include a feed arm comprising a layer of conductive material (e.g., copper). The feed arm may include a slit 414 in the conductive layer to provide current crowding for the high end of the frequency band. This gives the appearance at the upper limit of the desired frequency range of the driven element to be relatively shorter in length than the entire length of the driven element. This also gives the appearance at the lower limit of the desired frequency range of the driven element to be relatively longer in length than the entire length of the driven element. This allows for the driven element to appear to have different electrical lengths in terms of wavelengths compared to measuring the length of the element in terms of physical length. As such, this arrangement may provide a benefit as the current crowding makes the length of the feed arm appear to be smaller at the high frequency end of the band, which can allow for better impedance matching and antenna pattern shaping. And also, the current crowding at the low end of the frequency band can make this arm appear to be longer and can assist with the impedance matching at the low end of the band.

The non-conductive cover may be removed in some applications where one or more radiating structures are placed in a much larger overall non-conductive housing that includes the 5G radio or other telecommunication electronics. In some instances, multiple radiating structures can be placed at a fixed spacing and orientation and then enclosed in single non-conductive cover for technical or aesthetic purposes. In some instances, the non-conductive cover can be completely removed and the radiating structure can be coated with an environmental protective substance to reduce weight, or size, or cost for implementation purposes.

In FIG. 1, the coaxial connector is releasably attached to the non-conductive cover. In some applications, the non-conductive cover is realized in at least one part. In some configurations, the non-conductive cover may include two parts or more. When the two parts are releasably joined together, a mechanical feature encapsulates the radiating structure and the coaxial connector. In some cases, a SubMiniature version A (SMA) connector is used that may also include a knuckle assembly. In some instances, the coaxial connector includes a coaxial cable. The coaxial cable may be separated (i.e., pigtail) and stripped to be soldered. In some cases, the outer and center conductor of the coaxial cable is soldered to the PCB. In some cases, the antenna assembly is placed into one half of the radome and the other side of the radome is snapped into place to form the completed assembly.

In some applications, the assembly is only used indoors and does not require any environmental considerations. In some applications, the assembly is designed for an outdoor application and o-rings, weather gaskets, dispensed bonding material, and other environmental measures are taken to weather proof the novel device. In some cases, to operate in an outdoor application, the antenna assembly may include plastic parts designed to hold and compress a gasket that may provide the weather sealing.

In FIG. 4A, the outer conductor of the coaxial cable is mechanically and electrically attached to the coaxial connector. In some cases, the outer conductor of the coaxial cable may be coupled to the groundplane of the radiating structure. In some cases, the outer conductor may be electrically bonded to the groundplane of the radiating structure. In some applications, this electrical bonding may be accomplished by a soldering process. In some applications, the outer conductor may be coupled by a mechanical crimping process followed by a stacking or one or more mechanical fasteners. The slots in the RF supporting material of the printed circuit board allow for this component to translate internal to the non-conductive cover. In some applications, the coaxial connector may collapse in orientation. In some applications, this collapsing is desirable when the antenna assembly is desired to be in a different orientation than the connection point for the coaxial connector. In some cases, the coaxial cable may include a knuckle that allows the coaxial cable to bend. In some configurations, the coaxial cable may bend to form a 45-degree bend or a 90-degree bend. In some cases, the coaxial cable may include a continuous bend angle of choices if the knuckle is a friction knuckle (rather than one with detents in the plastic parts).

In some examples, the coaxial feed 409 may include a plurality of contact points to one or more of the conductive arms 408A-G. The coaxial feed 409 may contact conductive components on the antenna assembly. For example, the plurality of contact points may contact both a first side and a second side of the antenna assembly.

In some examples, each of the conductive arms 408A-G may have one or more bends along a length. For example, the first conductive arm 408A may extend from a first area to a second area. The first conduct arm 408A may have a shape defining a conductive surface of the conductive arm 408A. The shape may be any geometric shape. The geometric shape may include a length and a width. The length may extend parallel (or substantially parallel) from the first area to the second area. The width may extend perpendicular (or substantially perpendicular) to the length. In some cases, the conductive arm 408A may have no bends along the length or one or more bends along the length. For example, the conductive arm 408A may have a bend along the length, with the bend being between 0-degrees and 90-degrees. In some examples, the width of the conductive surface may be the same (or substantially the same) along the length or, in some cases, varies along the length. As illustrated, the width of the first conductive arm 408A is wider at a first area than at a second area.

In FIG. 4B, the center conductor of the coaxial cable is electrically isolated from the groundplane in FIG. 4A and is electrically connected to the microstrip feed line. In FIG. 4B, the microstrip feedline linearly tapers in width from its initial dimension at the coax cable soldering point to the desired width for impedance matching just before the driven dipole feature.

In FIGS. 6A and 6B, an exemplary feed configuration is illustrated. In some instances, the feed assembly may include a feed element, including an outer conductor 606, an insulator 608, and an inner conductor 610. The feed assembly may be coupled to a PCB. The PCB may include a first side and a second side. The first side and the second side may include a first non-conductive surface 602 and a first conductive surface 604. In some cases, the outer conductor 606 may be coupled to the first conductive surface 604 of the first side. In some cases, the inner conductor 610 may be coupled to a second conductive surface 622 of the second side. In some instances, the inner conductor 610 may pass from the first side to the second side via a through hole of the PCB.

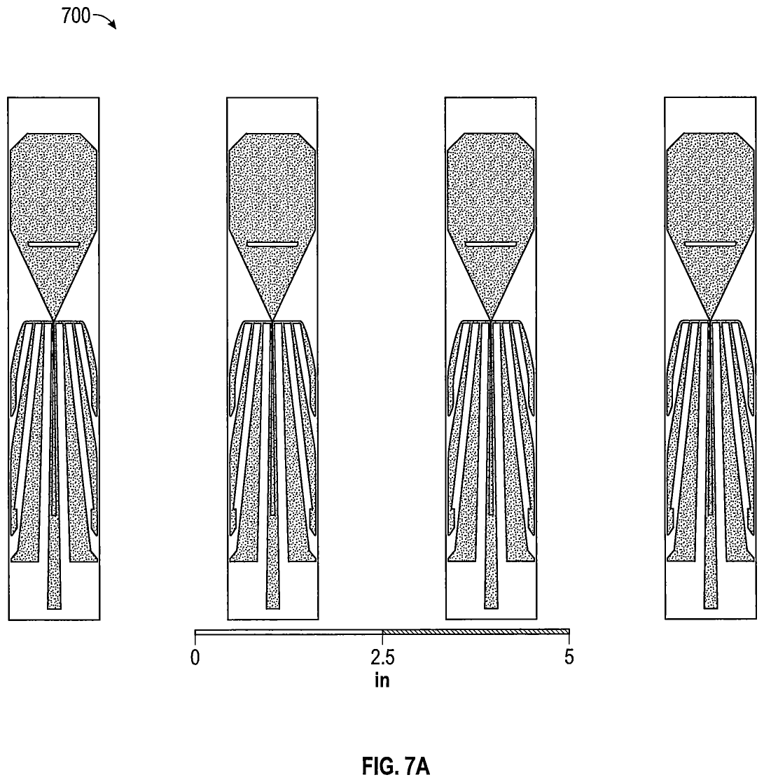

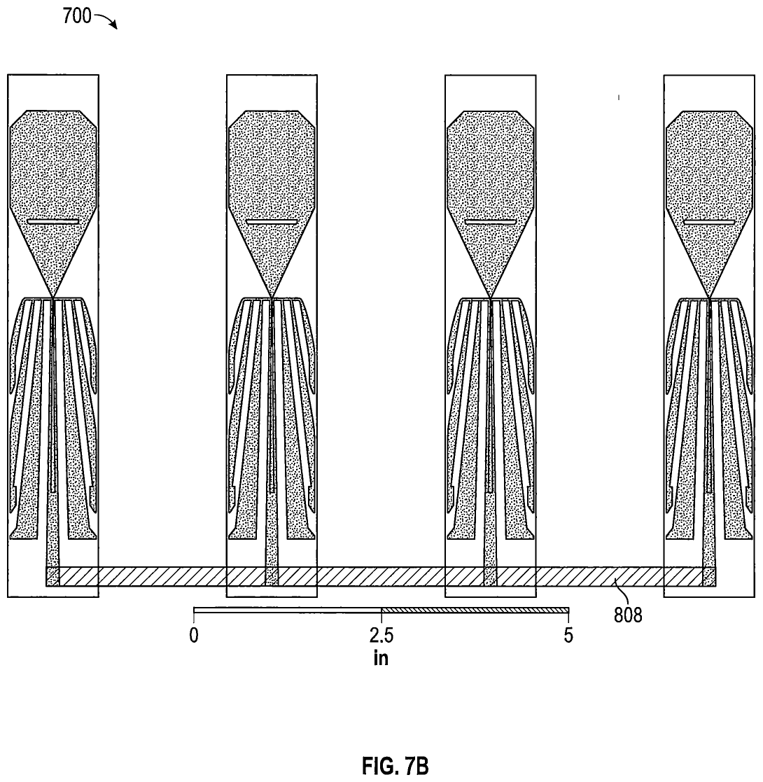

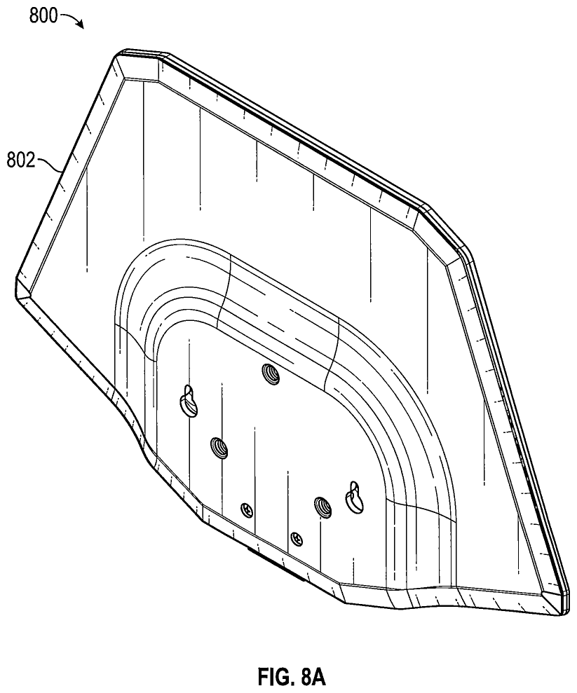

In FIGS. 7A and 7B, an antenna assembly is shown with at least two printed circuit boards (PCBs). As illustrated in FIG. 7A, the antenna assembly 700 may include a novel element (such as the omni-directional antenna of FIGS. 4A-4B disclosed herein) used in conjunction with other radiating portions of similar nature. All radiating portions may coincide on a similar plane or may be spread across a three dimensional space. Each of the PCBs may include a first side and a second side. In some examples, each of the PCBs may include a counter pose element formed on the first side, wherein the counter pose element comprises one or more conductive elements, wherein lengths of the one or more conductive elements correspond to a band of operation for the antenna assembly. In some examples, each of the PCBs may include a driven element formed on the second side and comprising a slit that allows for current crowding of the driven element. In some examples, the antenna assembly may include a feed element coupled to each of the PCBs, wherein the feed element is configured to energize the driven element for each of the PCBs. In some examples, the antenna assembly may include a grounding portion coupled to each of the PCBs. The number of PCBs may adjust according to the application. For example, as illustrated, four PCBs are shown. In some instances, two or more radios may work in tandem to focus or steer the resulting antenna beam in the horizontal or azimuth orientation as depicted in FIG. 7A. In some examples, the number of PCBs may be greater or fewer depending on the application. For example, it may be advantageous for multiple portions of the radiating element to be placed in close proximity and be sufficiently efficient for wireless communication. One application can be for placing this antenna structure in an office building window. Another installation can be a side window of a motor vehicle. It may be advantageous to place multiple radiating portions in close proximity in a planar fashion to reduce visual impact as well as manufacturing expenses. In some installations, the PCBs are parallel to one another. In some installations, the PCBs share a common planar surface and have unique rotational orientations to one another.

As illustrated in FIG. 7B, the antenna assembly may include a bonding portion 808 coupling each of the PCBs to one another. The bonding portion 808 may be constructed of non-conductive and/or conductive material applicable for the application. For example, the bonding portion 808 may be constructed of conductive material to ground each of the conductive elements with which the grounding portion 808 comes into contact. The bonding portion 808 may be constructed of rigid material. The rigid material may provide structural support to restrain movement of the PCBs. In some examples, the bonding portion 808 may be positioned along a straight line and configured to couple to a portion of the one or more conductive elements for each of the PCBs. For example, the bonding portion 808 may be coupled to a central conductive element for each of the PCBs. In this manner, the bonding portion 808 may be positioned at an end point of the central conductive element for each of the PCBs. The bonding portion 808 may be positioned along other conductive elements for each of the PCBs. In some examples, the bonding portion 808 may have a plurality of segments, where each of the plurality of segments couples one PCB with another. For example, the bonding portion 808 may include a first portion coupling a first PCB with a second PCB and a second portion (separate from the first portion) coupling the second PCB with a third PCB. In this manner, the bonding portion 808 may be coupled to different conductive elements for each of the PCBs. In some examples, the bonding portion 808 may be useful for routing of transmission lines to a common point for later connection to a wireless radio or modem.

In some examples, the length of conducting portions 408A-G may adjust according to an operating frequency range. For example, when using a bonding portion 808 or when placing the radiating portions in close proximity to one another, the length of conducting portions 408A-G may reduce in length to maintain the desired frequency range of operation (for example, in the 5G frequency spectrum). In some examples, adjusting the length of the conducting portions 408A-G may reduce mutual coupling between the conductive portions 408A-G. This is due to the effect of mutual coupling between the radiating portions and its impact on the individual impedance of the components of each radiating portion. In some examples, the length of the conductive portions 408A-G may adjust, “tune”, to achieve a resonant frequency of the individual conducting portions 408A-G for optimum performance for a particular application (for example, in an imbedded environment).

The particular implementations disclosed above are illustrative only, as the application may be modified and practiced in different but equivalent manners apparent to those skilled in the art having the benefit of the teachings herein. It is therefore evident that the particular implementations disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

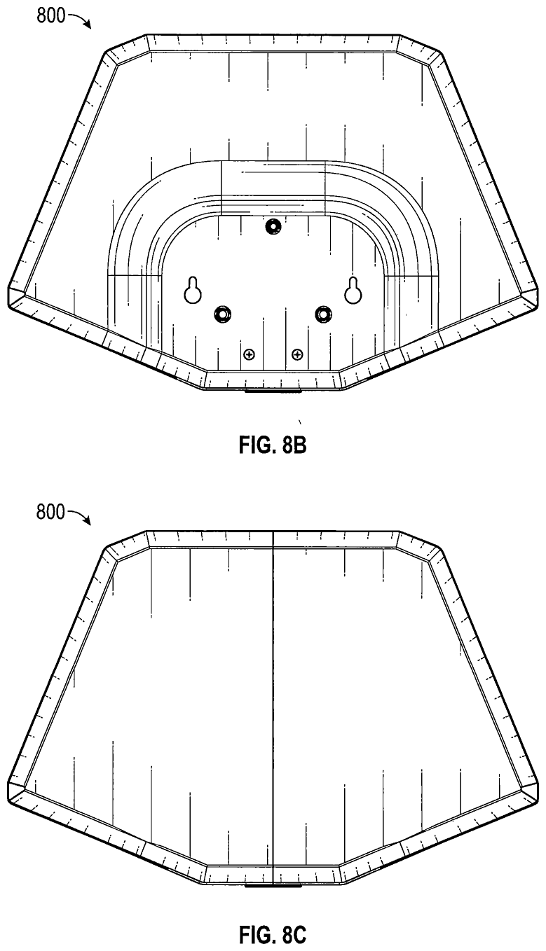

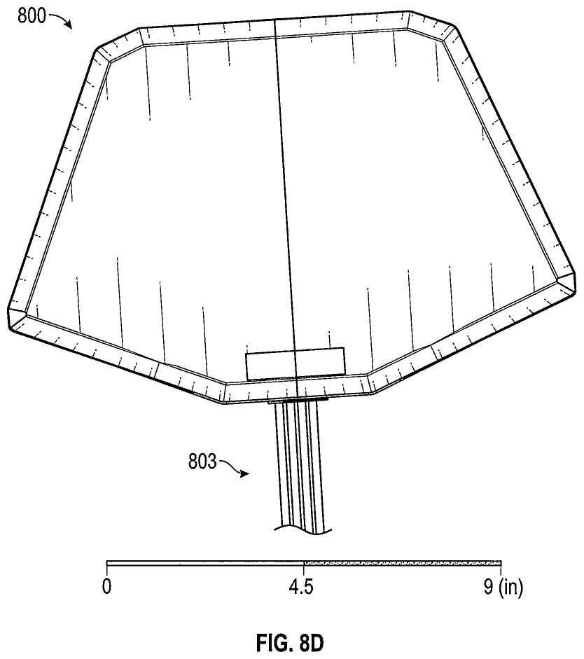

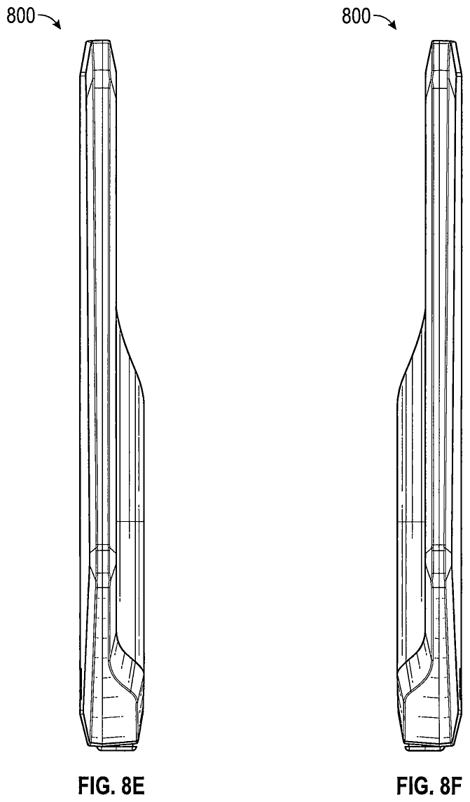

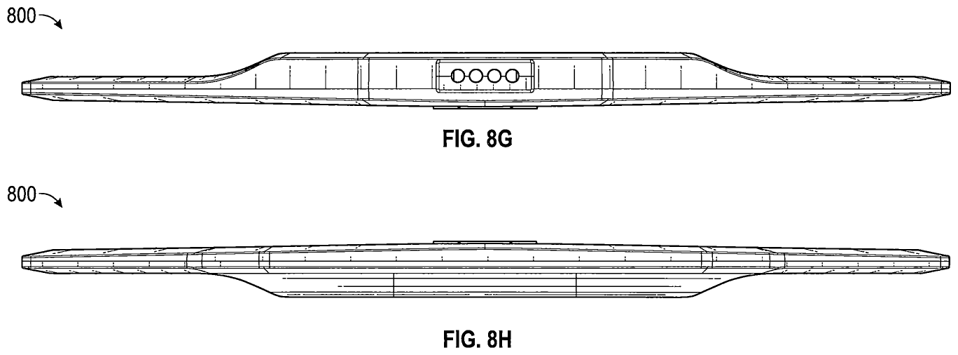

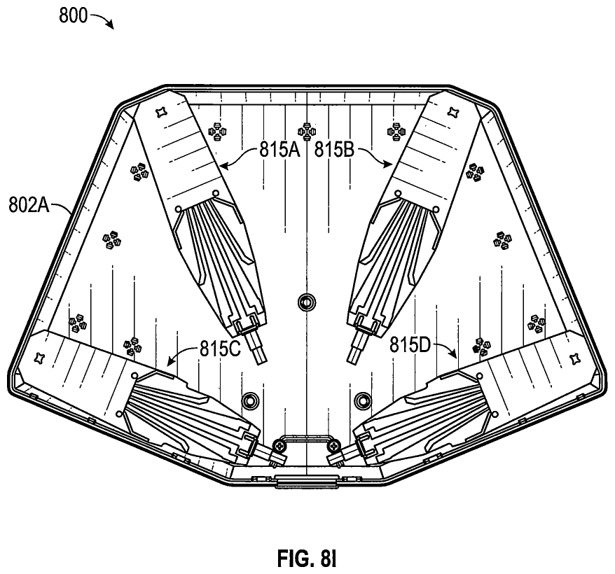

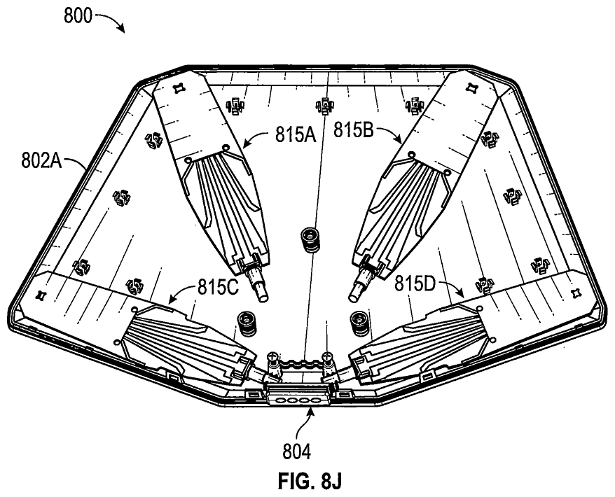

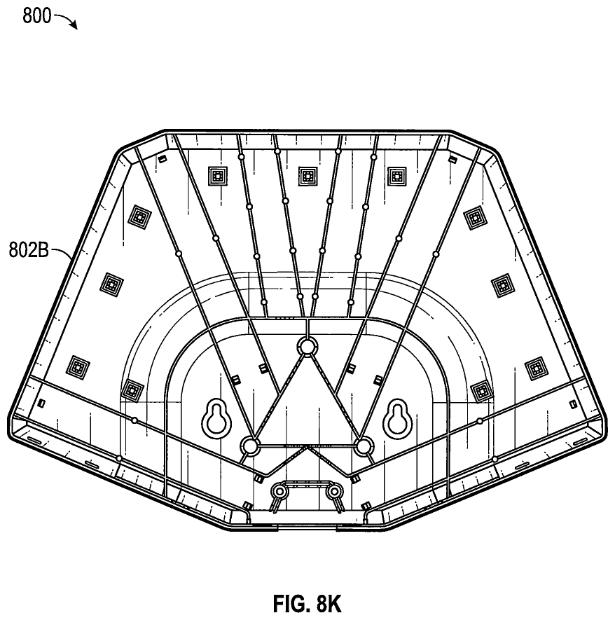

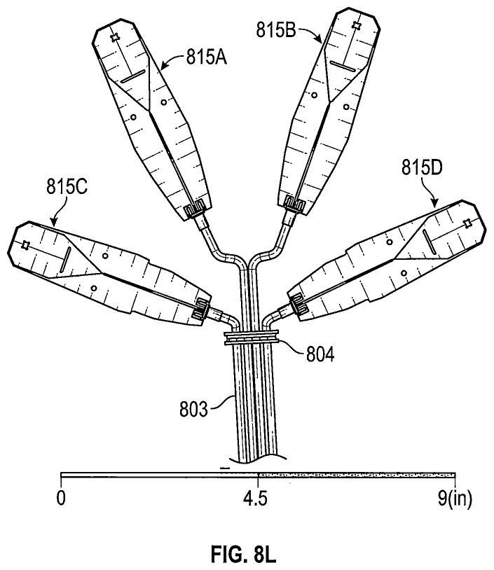

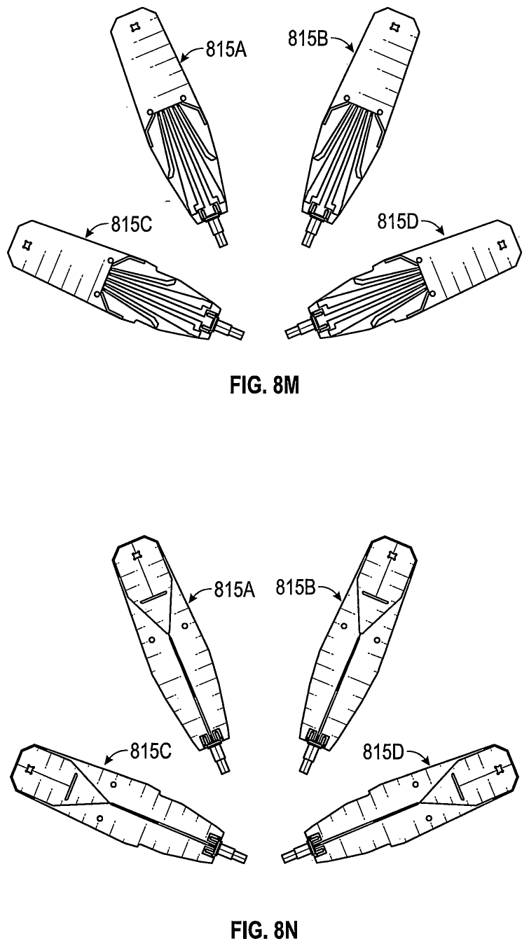

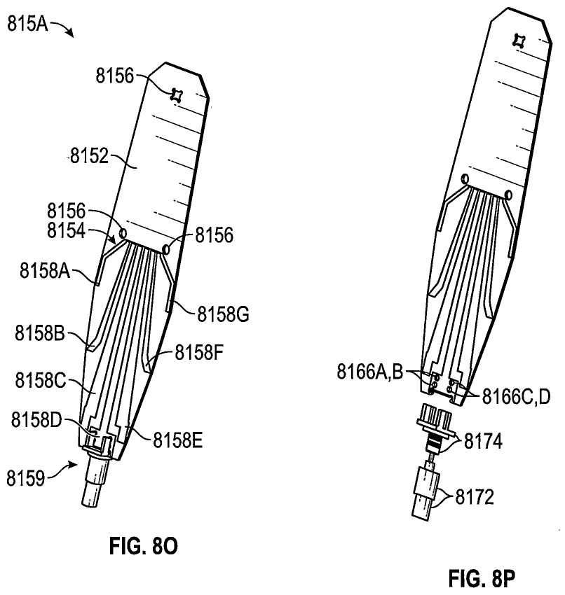

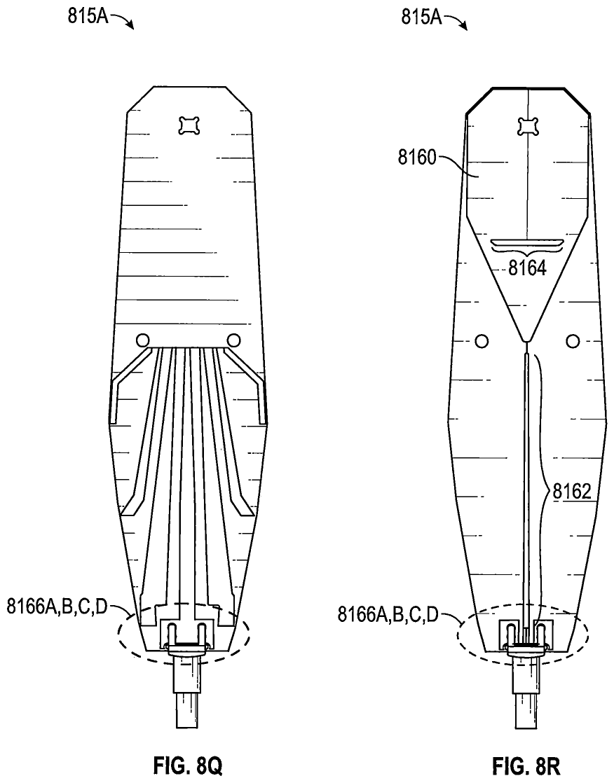

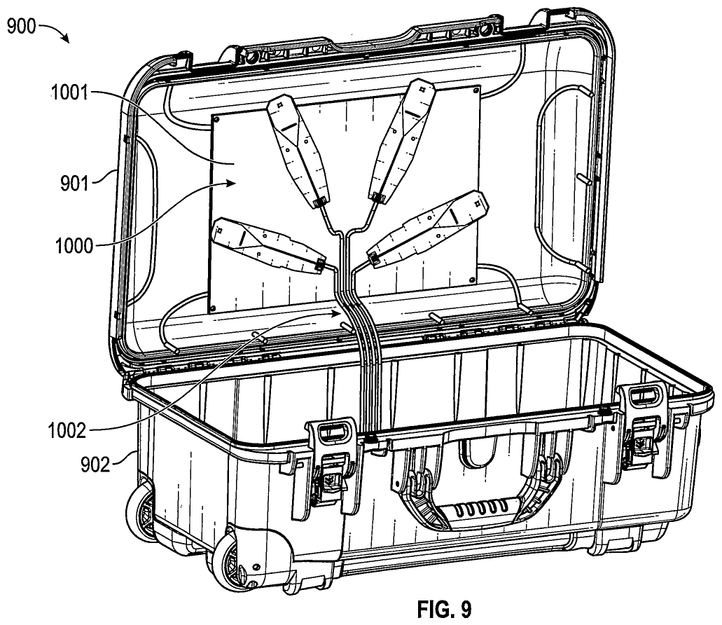

FIG. 8A shows a perspective view of an antenna assembly 800. The antenna assembly 800 may include any and/or all of the features as described herein (for example, with respect to antenna assembly 100 and 200 and/or any components with respect to the antenna assemblies as described herein). FIGS. 8B-8H show various views of the antenna assembly 800.

FIGS. 8I-8J show various views of the antenna assembly 800 without a radome component, exposing internal hardware of the antenna assembly 800. As illustrated in FIGS. 8I-8J, the antenna assembly 800 includes a radome component 802A, gasket 804, one or more omni-directional antennas 815A-D. The radome 802 (and components thereof) may include any and/or all of the aspects as described herein (for example, as described for radome 102, 202 and radome component 302, 306). FIG. 8K shows an interior portion of a radome component 802B. The radome component 802B may include components for restraining the one or more omni-directional antennas 815A-D and attaching to the radome component 802A (for example, to form the radome 802). In some examples, the antenna assembly 800 may include mechanical fastening components (or a capability to receive mechanical fastening components). For example, the mechanical fastening components may allow the antenna assembly 800 to mount to a wall (such as, the antenna assembly 800 may include slots or openings in the radome 802 to allow the mechanical fastening components to pass through and mount the antenna assembly 800).

FIGS. 8L-8N show various views of the omni-directional antennas 815A-D. FIG. 8L illustrates each of the antennas 815A-D connected to the one or more coaxial cable 803 (such as, a coaxial cable to provide an RF transmission line). The one or more coaxial cable 803 may each connect to one of the omni-directional antennas 815A-D. The one or more coaxial cable 803 may provide an RF transmission line between an RF source (such as, a 3GPP radio) and the omni-directional antennas 815A-D. The one or more coaxial cable 803 may be positioned by a gasket 804. In some examples, the gasket 804 may provide a seal between the radome components 802A,B (as shown, e.g., in FIGS. 8I-8K) and the coaxial cables.

In some examples, the omni-directional antennas 815A-D may each have a different orientation than the other omni-directional antennas. In some examples, the omni-directional antennas 815A-D may be oriented in unique directions to provide polarization diversity for the radio link between the RF source and a receiving device (such as, a 3GPP basestation or other 3GPP device). In some examples, one of the omni-directional antennas 815A-D may have a degree offset from another of the omni-directional antennas 815A-D. For example, the omni-directional antennas 815A,815B may be positioned in a manner that an axis along the length of each of the antennas 815A,815B has an offset angle of between 0-degrees to 360-degrees.

In some examples, the omni-directional antennas 815A-D may each have a polarization. For example, the polarization may be angled Slant 45 polarization, +45 degrees and −45 degrees from vertical. In some cases, with four unique radiators, the polarization may be −67.5 degrees, −22.5 degrees, +22.5 degrees, +67.5 degrees. There are many different variations from +/−45 degrees based on the multipath characteristics of the environment that the antenna assembly 800 will be deployed. The components of the omni-directional antennas 815A-D may be the same (or substantially similar) to those described herein (for example, as described with respect to FIGS. 4A-4B).

FIGS. 8M-8N illustrate a first side and a second side, respectively, for each of the omni-directional antennas 815A-D. FIGS. 8O-8P show perspective views of one of the omni-directional antennas 815A. The omni-directional antennas as described herein may each have the same (or substantially the same) features, aspects, characteristics, and functions as any of the omni-directional antenna as described herein (for example, the omni-directional antenna 315, 815A-D). FIG. 8O shows an assembled view of the omni-directional antenna 815A. The antenna 815A may include a first non-conductive surface 8152, first conductive surface 8154, mechanical fastening point 8156, conductive arms 8158A-G, connector 8159, and a second conductive surface 8160. FIG. 8P shows an exploded view of the omni-directional antenna 815A. The antenna 815A may include a plurality of feed points 8166A-D. The connector 8159 may include coaxial feed components 8172 and a feed assembly 8174.

FIGS. 8Q-8R show a first view and a second view, respectively, of the omni-directional antenna 815A. The second view shows the second conductive surface 8160, a feedline 8162, a slit 8164, and the plurality of electrical bonding points 8166A-D.

FIG. 9 illustrates an example case antenna system 900. The case antenna system 900 may include a lid 901, a base 902, an antenna assembly 1000, a non-conductive support sheet 1001, coaxial cables 1002, and an RF source (not shown). The lid 901 may include a cavity, in which the antenna assembly 1000 and the non-conductive support sheet 1001 may be positioned. In some examples, the RF source may be positioned in the base 902. The coaxial cables 1002 may extend from the RF source to the antenna assembly 1000 (for example, as described in FIGS. 8K-8L herein). In some examples, the antenna assembly may function with the lid 901 in a closed position (for example, the lid 901 contacting the base 902). In some examples, the antenna assembly may function with the lid 901 and in an open position (for example, the lid 901 positioned perpendicular (or substantially perpendicular) to the base 902. Additional case antenna systems are disclosed in U.S. patent application Ser. No. 18/918,604 and PCT Application No. PCT/US2024/048705, and additional inventive combinations of features and example implementations can be combined with any one or more features, aspects, and/or implementations of the present disclosure, including those disclosed herein with respect to aspects, systems, and components of the case antenna system described and shown in connection with FIG. 9 herein.

### Additional Disclosures

Example implementations of the present disclosure include disclosures presented in the patent applications incorporated by reference herein. These applications disclose additional figures, implementations, features and/or aspects of devices, systems, and methods related to antenna systems and/or systems and methods for wireless communications that form parts or portions of the present disclosure, including, without limitation, disclosure that supports claims and/or clauses of the present application and/or related applications, which disclosure can be relied upon and/or bodily incorporated, in whole or in part, and presented herein in its entirety for all purposes and for all that it contains. Furthermore, additional inventive combinations of features are disclosed herein, and example implementations can be combined with any one or more features, aspects, and/or implementations of the present disclosure.

U.S. patent application Ser. No. 18/918,604, filed Oct. 17, 2024, entitled “ANTENNA SYSTEMS,” which is hereby incorporated by reference herein in its entirety for all purposes and for all that it contains, discloses additional figures, implementations, features and/or aspects of devices, systems, and methods, that support claims of the present application and/or related applications, which disclosure can be relied upon and/or bodily incorporated, in whole or in part, and presented herein in its entirety for all purposes and for all that it contains.

PCT Application No. PCT/US2024/048705, filed Sep. 26, 2024, entitled “ANTENNA SYSTEMS,” which is hereby incorporated by reference herein in its entirety for all purposes and for all that it contains, discloses additional figures, implementations, features and/or aspects of devices, systems, and methods, that support claims of the present application and/or related applications, which disclosure can be relied upon and/or bodily incorporated, in whole or in part, and presented herein in its entirety for all purposes and for all that it contains.

### EXAMPLE CLAUSES

Various examples of systems relating to an antenna system are found in the following clauses:

Clause 1. An antenna assembly, comprising: a radome; at least two printed circuit boards (PCBs) configured to be housed by the radome, wherein each of the least two PCBs comprises a first side and a second side, wherein each of the least two PCBs comprises: a counter pose element formed on the first side, wherein the counter pose element comprises one or more conductive elements, wherein lengths of the one or more conductive elements correspond to a band of operation for the antenna assembly; and a driven element formed on the second side and comprising a slit that allows for current crowding of the driven element; a feed element coupled to each of the least two PCBs, wherein the feed element is configured to energize the driven element for each of the least two PCBs; and a grounding portion coupled to each of the at least two PCBs.

Clause 2. The antenna assembly of Clause 1, wherein the grounding portion comprises a rigid material positioned along a straight line and configured to couple to a portion of the one or more conductive elements for each of the least two PCBs.

Clause 3. The antenna assembly of Clause 1, wherein the slit for each of the least two PCBs is configured to adjust an electrical length of the driven element.

Clause 4. The antenna assembly of Clauses 3, wherein the electrical length of the driven element corresponds to a transmission frequency range, wherein the electrical length of the driven element is shorter than a physical length of the driven element at higher frequencies and the electrical length of the driven element is longer than the physical length of the driven element at lower frequencies.

Clause 5. The antenna assembly of Clause 1, wherein the driven element comprises a feedline that linearly tapers in width from a first point to a second point.

Clause 6. The antenna assembly of Clause 5, wherein the feedline is configured to transform a feed impedance of a transmission line from a characteristic impedance to an impedance of the driven element.

Clause 7. The antenna assembly of Clause 1, wherein the one or more conductive elements of the counter pose element comprise a plurality of radiating arms.

Clause 8. The antenna assembly of Clause 7, wherein the plurality of radiating arms are each connected by a single feature.

Clause 9. The antenna assembly of Clause 7, wherein at least two of the plurality of radiating arms are of a different length.

Clause 10. The antenna assembly of Clauses 8-9, wherein the plurality of

radiating arms correspond to a frequency range, wherein a shortest radiating arm corresponds to a higher end of the frequency range and a longest radiating arm corresponds to a lower end of the frequency range.

Clause 11. The antenna assembly of Clause 1, wherein the driven element comprises a conductive layer, wherein the slit is included in the conductive layer.

Clause 12. The antenna assembly of Clause 1, further comprising a pivotable arm coupled to the feed element and configured to pivot along an axis of rotation and provide the antenna assembly a plurality of orientations.

Clause 13. The antenna assembly of Clause 1, wherein the radome comprises two parts releasably joined together.

Clause 14. The antenna assembly of Clause 1, wherein the antenna assembly is configured to produce omni-directional radiation pattern.

Clause 15. The antenna assembly of Clause 1, wherein the antenna assembly is configured to produce directional radiation pattern.

Clause 16. The antenna assembly of Clause 1, wherein the radome is configured to compress a gasket when assembled to be configured for outdoor use.

Clause 17. The antenna assembly of Clause 1, wherein the feed element comprises an outer conductor, an insulator, and an inner conductor.

Clause 18. The antenna assembly of Clause 17, wherein the outer conductor is coupled to the first side for each of the at least two PCBs.

Clause 19. The antenna assembly of Clause 17, wherein the inner conductor is coupled to the second side for each of the at least two PCBs.

Clause 20. The antenna assembly of Clause 17, wherein the insulator is configured to electrically isolate the inner conductor from the outer conductor.

Clause 21. An antenna assembly, comprising a radome; one or more printed circuit boards (PCBs) configured to be housed by the radome, wherein each of the one or more PCBs comprises a first side and a second side, wherein each of the one or more PCBs comprises: a counter pose element formed on the first side, wherein the counter pose element comprises one or more conductive elements, wherein lengths of the one or more conductive elements correspond to a band of operation for the antenna assembly; and a driven element formed on the second side and comprising a slit that allows for current crowding of the driven element; a feed element coupled to each of the one or more PCBs, wherein the feed element is configured to energize the driven element for each of the one or more PCBs; and a grounding portion coupled to each of the one or more PCBs.

Clause 22. The antenna assembly of Clause 21, wherein the grounding portion comprises a rigid material positioned along a straight line and configured to couple to a portion of the one or more conductive elements for each of the one or more PCBs.

Clause 23. The antenna assembly of Clause 21, wherein the slit for each of the one or more PCBs is configured to adjust an electrical length of the driven element.

Clause 24. The antenna assembly of Clause 23, wherein the electrical length of the driven element corresponds to a transmission frequency range, wherein the electrical length of the driven element is shorter than a physical length of the driven element at higher frequencies and the electrical length of the driven element is longer than the physical length of the driven element at lower frequencies.

Clause 25. The antenna assembly of Clause 21, wherein the driven element comprises a feedline that linearly tapers in width from a first point to a second point.

Clause 26. The antenna assembly of Clause 25, wherein the feedline is configured to transform a feed impedance of a transmission line from a characteristic impedance to an impedance of the driven element.

Clause 27. The antenna assembly of Clause 21, wherein the one or more conductive elements of the counter pose element comprise a plurality of radiating arms.

Clause 28. The antenna assembly of Clause 27, wherein the plurality of radiating arms are each connected by a single feature.

Clause 29. The antenna assembly of Clause 27, wherein at least two of the plurality of radiating arms are of a different length.

Clause 30. The antenna assembly of Clause 28, wherein the plurality of radiating arms correspond to a frequency range, wherein a shortest radiating arm corresponds to a higher end of the frequency range and a longest radiating arm corresponds to a lower end of the frequency range.

Clause 31. The antenna assembly of Clause 29, wherein the plurality of radiating arms correspond to a frequency range, wherein a shortest radiating arm corresponds to a higher end of the frequency range and a longest radiating arm corresponds to a lower end of the frequency range.

Clause 32. The antenna assembly of Clause 21, wherein the driven element comprises a conductive layer, wherein the slit is included in the conductive layer.

Clause 33. The antenna assembly of Clause 21, further comprising a pivotable arm coupled to the feed element and configured to pivot along an axis of rotation and provide the antenna assembly a plurality of orientations.

Clause 34. The antenna assembly of Clause 21, wherein the radome comprises two parts releasably joined together.

Clause 35. The antenna assembly of Clause 21, wherein the antenna assembly is configured to produce omni-directional radiation pattern.

Clause 36. The antenna assembly of Clause 21, wherein the antenna assembly is configured to produce directional radiation pattern.

Clause 37. The antenna assembly of Clause 21, wherein the radome is configured to compress a gasket when assembled to be configured for outdoor use.

Clause 38. The antenna assembly of Clause 21, wherein the feed element comprises an outer conductor, an insulator, and an inner conductor.

Clause 39. The antenna assembly of Clause 38, wherein the outer conductor is coupled to the first side for each of the one or more PCBs.

Clause 40. The antenna assembly of Clause 38, wherein the inner conductor is coupled to the second side for each of the one or more PCBs.

Clause 41. The antenna assembly of Clause 38, wherein the insulator is configured to electrically isolate the inner conductor from the outer conductor.

### Additional Considerations and Terminology

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations, and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise, the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

What is claimed is:

1. An antenna assembly, comprising:
a radome;
one or more printed circuit boards (PCBs) configured to be housed by the radome, wherein each of the one or more PCBs comprises a first side and a second side, wherein each of the one or more PCBs comprises:
a counter pose element formed on the first side, wherein the counter pose element comprises one or more conductive elements, wherein lengths of the one or more conductive elements correspond to a band of operation for the antenna assembly; and
a driven element formed on the second side and comprising a slit that allows for current crowding of the driven element;
a feed element coupled to each of the one or more PCBs, wherein the feed element is configured to energize the driven element for each of the one or more PCBs; and
a grounding portion coupled to each of the one or more PCBs.

2. The antenna assembly of claim 1, wherein the grounding portion comprises a rigid material positioned along a straight line and configured to couple to a portion of the one or more conductive elements for each of the one or more PCBs.

3. The antenna assembly of claim 1, wherein the slit for each of the one or more PCBs is configured to adjust an electrical length of the driven element.

4. The antenna assembly of claim 3, wherein the electrical length of the driven element corresponds to a transmission frequency range, wherein the electrical length of the driven element is shorter than a physical length of the driven element at higher frequencies and the electrical length of the driven element is longer than the physical length of the driven element at lower frequencies.

5. The antenna assembly of claim 1, wherein the driven element comprises a feedline that linearly tapers in width from a first point to a second point.

6. The antenna assembly of claim 5, wherein the feedline is configured to transform a feed impedance of a transmission line from a characteristic impedance to an impedance of the driven element.

7. The antenna assembly of claim 1, wherein the one or more conductive elements of the counter pose element comprise a plurality of radiating arms.

8. The antenna assembly of claim 7, wherein the plurality of radiating arms are each connected by a single feature.

9. The antenna assembly of claim 7, wherein at least two of the plurality of radiating arms are of a different length.

10. The antenna assembly of claim 8, wherein the plurality of radiating arms correspond to a frequency range, wherein a shortest radiating arm corresponds to a higher end of the frequency range and a longest radiating arm corresponds to a lower end of the frequency range.

11. The antenna assembly of claim 9, wherein the plurality of radiating arms correspond to a frequency range, wherein a shortest radiating arm corresponds to a higher end of the frequency range and a longest radiating arm corresponds to a lower end of the frequency range.

12. The antenna assembly of claim 1, wherein the driven element comprises a conductive layer, wherein the slit is included in the conductive layer.

13. The antenna assembly of claim 1, further comprising a pivotable arm coupled to the feed element and configured to pivot along an axis of rotation and provide the antenna assembly a plurality of orientations.

14. The antenna assembly of claim 1, wherein the radome comprises two parts releasably joined together.

15. The antenna assembly of claim 1, wherein the antenna assembly is configured to produce omni-directional radiation pattern.

16. The antenna assembly of claim 1, wherein the antenna assembly is configured to produce directional radiation pattern.

17. The antenna assembly of claim 1, wherein the radome is configured to compress a gasket when assembled to be configured for outdoor use.

18. The antenna assembly of claim 1, wherein the feed element comprises an outer conductor, an insulator, and an inner conductor.

19. The antenna assembly of claim 18, wherein the outer conductor is coupled to the first side for each of the one or more PCBs.

20. The antenna assembly of claim 18, wherein the inner conductor is coupled to the second side for each of the one or more PCBs.

21. The antenna assembly of claim 18, wherein the insulator is configured to electrically isolate the inner conductor from the outer conductor.
